(19) United States
(12) Patent Application Publication
(10) Pub. No.: US 2025/0332775 A1
(43) Pub. Date: Oct. 30, 2025

(54) optical lens injection molding module

(71) Applicant: JUN HE TECHNOLOGY CO., LTD., FUXING TOWNSHIP (TW)

(72) Inventor: CHIANG-CHUAN WANG, FUXING TOWNSHIP (TW)

(21) Appl. No.: 18/650,010

(22) Filed: Apr. 29, 2024

(51) Int. Cl. B29C 45/73; B29C 33/38; B29L 11/00; B33Y 80/00

(52) U.S. Cl. CPC B29C 45/7337; B29C 33/3842; B33Y 80/00; B29L 2011/0016

(57) ABSTRACT

An optical lens injection molding module is presented, wherein the molding module has a mold core made by a metal 3D printer. The metal 3D printer first lays metal powder on a platform and then transmits laser heat energy for irradiation sintering to melt the metal powder together into a predetermined shape as a metal layer, and by repeated formation of a plurality of metal layers. The mold core has a top surface, a bottom surface, a peripheral wall, a through aperture, a plurality of mold cavities, and at least one temperature controlled flow channel. The mold cavities and the temperature controlled flow channel are disposed in the mold core. The through aperture is disposed at a center of a circular position of all the mold cavities, penetrates both of the top surface and the bottom surface, and connects radially to each mold cavity via a plurality of guiding grooves.

### BACKGROUND OF THE INVENTION

### Field of Invention

The present invention relates to a molding module, and more particularly to an optical lens injection molding module.

### Description of the Related Art

Accordingly, as shown in FIGS. 11 to 14, an optical lens injection molding module includes: an upper mold base 41, a lower mold base 42 and a mold core set 50. The upper and lower mold bases 41, 42 are used for injection molding of optical lenses. The upper mold base 41 and the lower mold base 42 respectively have a first surface 43 and a second surface 44, and the first surfaces 43 of the upper mold base 41 and the lower mold base 42 are provided with a concave mold core hole 49 toward to the second surface 44. When the upper and lower mold bases 41 and 42 are closed, the first surfaces 43 of the two mold bases 41 and 42 are aligned to seal the mold core set 50, and then the plastic material is heated and melted by an injection molding machine and then injected into the mold structure 40. The mold core group 50 includes a first mold core 51, a second mold core 52 and a third mold core 53, and a through hole 513 is opened at the center of the first mold core 51 and is connected with a plurality of guide grooves 512. When the plastic material is filled in the mold cavity 511, the optical lens is successfully produced by the injection molding method. A first cooling channel 54 and a second cooling channel 55 is provided on the mold core set 50 aligned with the upper mold base 41 and the lower mold base 42. The two cooling channels 54, 55 are separated from the bottom of the mold cavity 511 without penetrating the mold cavity 511. The first cooling channel 54 is a curved annular groove disposed inside the mold core set 50 and between the bottoms of the first mold core 51 and the second mold core 52 without penetrating the mold cavity 511 and the second surface 44. The second cooling channel 55 is a curved annular groove disposed in the mold core set 50 and is located between the bottoms of the second mold core 52 and the third mold core 53 without penetrating the mold cavity 511 and the second surfaces 44. Furthermore, at least one coolant input channel 47 and at least one coolant output channel 48 are connected to two sides of the first cooling channel 54 and the second cooling channel 55 respectively.

However, the conventional structure as mentioned above still has the following problems in actual application: the first mold core 51, the second mold core 52 and the third mold core 53 all need to be cut with a tool first to smoothly forming the mold cavity 511, the guide groove 512, the through hole 513, the first cooling route 54 and the second cooling route 55, and then the assembly can be performed. Therefore, not only the production process is complicated and the processing cost is high, but also the production speed is too slow, which is not conducive to competition among the same industry. Also, the second mold core set 50 are combined by the first mold core 51, the second mold core 52 and the third mold core 53, so it has poor integrity and sealing issue too.

Therefore, it is desirable to provide an optical lens injection molding module to mitigate and/or obviate the aforementioned problems.

### SUMMARY OF THE INVENTION

An objective of present invention is to provide an optical lens injection molding module, which is capable of improving the above-mention problems.

In order to achieve the above-mentioned objective, an optical lens injection molding module is presented, wherein the molding module has a mold core made by a metal 3D printer. The metal 3D printer first lays metal powder on a platform and then transmits laser heat energy for irradiation sintering to melt the metal powder together into a predetermined shape as a metal layer, and by repeated formation of a plurality of metal layers. The mold core has a top surface, a bottom surface, a peripheral wall, a through aperture, a plurality of mold cavities, and at least one temperature controlled flow channel. The mold cavities and the temperature controlled flow channel are disposed in the mold core, and the temperature controlled flow channel passes around each mold cavity and penetrates the peripheral wall with at least one intake opening and at least one exit opening. The through aperture is disposed at a center of a circular position of all the mold cavities, penetrates both of the top surface and the bottom surface, and connects radially to each mold cavity via a plurality of guiding grooves.

Other objects, advantages, and novel features of invention will become more apparent from the following detailed description when taken in conjunction with the accompanying drawings.

### BRIEF DESCRIPTION OF THE DRAWINGS

FIG. 1 is a three-dimensional view of a preferred embodiment according to the present invention.

FIG. 2 is a block flow chart of the preferred embodiment according to the present invention.

FIG. 3 is a schematic drawing of the printing of the metal layer according to the present invention.

FIG. 4 is a another schematic drawing of the stacking of the metal layer according to the present invention.

FIG. 5 is another schematic drawing of the stacking of the metal layer according to the present invention.

FIG. 6 is another schematic drawing of the stacking of the metal layer of the present invention.

FIG. 7 is a plan view of the preferred embodiment according to the present invention.

FIG. 8 is a cross-sectional view of the preferred embodiment according to the present invention.

FIG. 9 is another cross-sectional view 2 of the preferred embodiment according to the present invention.

FIG. 10 is a perspective view of another preferred embodiment of the present invention.

FIG. 11 is a three-dimensional combination drawing of a prior art structure.

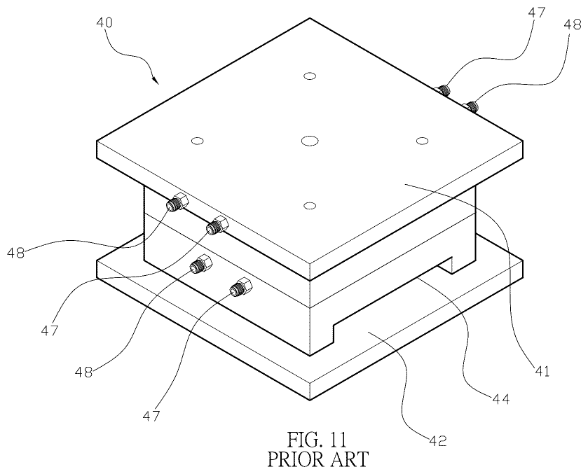

FIG. 12 is a three-dimensional exploded view of the prior art structure.

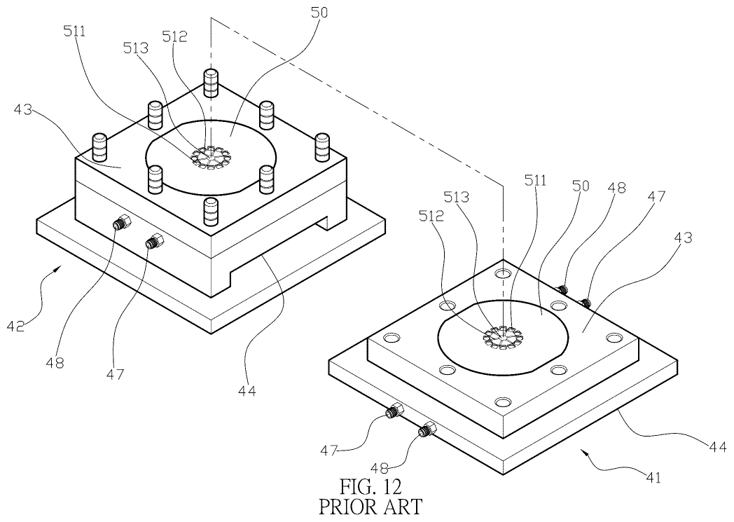

FIG. 13 is a detailed exploded view of the prior art structure.

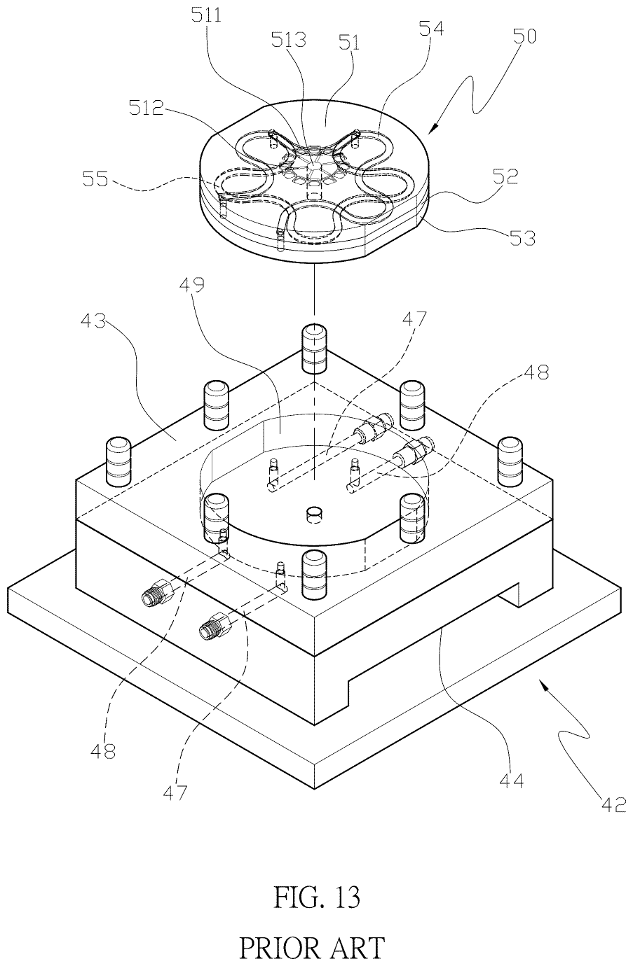

FIG. 14 is a three-dimensional exploded view of the mold core of the prior art structure.

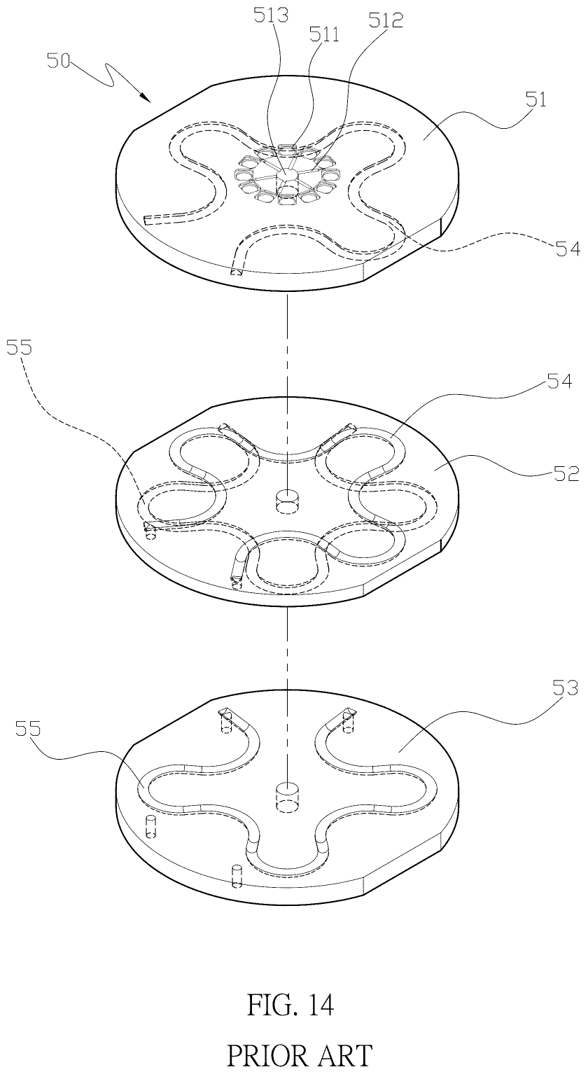

### DETAILED DESCRIPTION OF PREFERRED EMBODIMENT

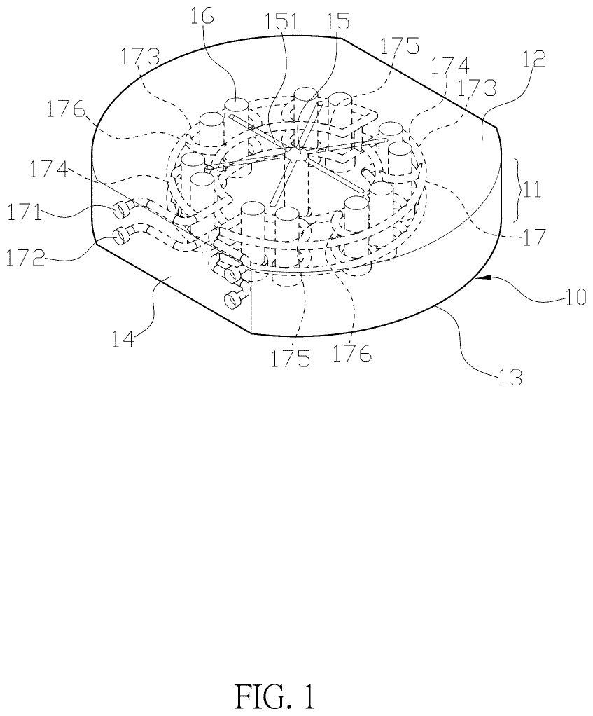

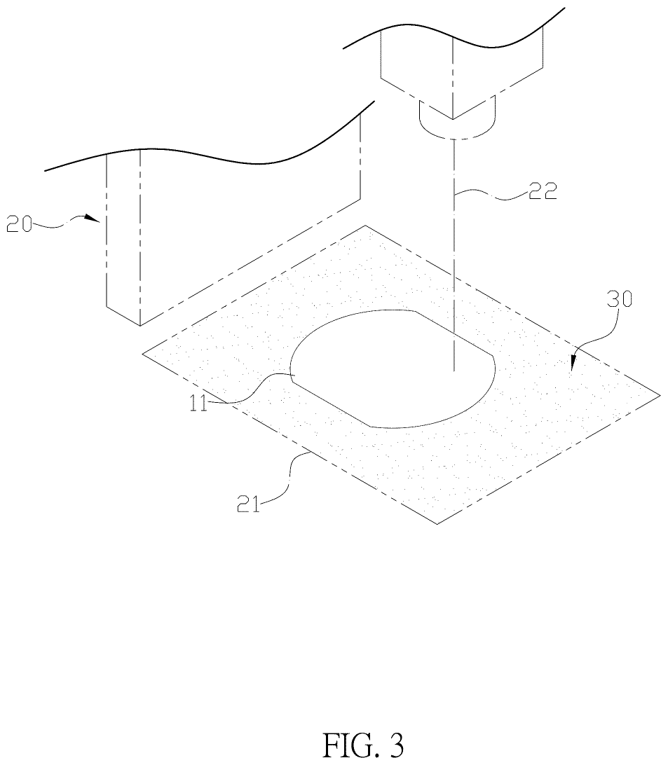

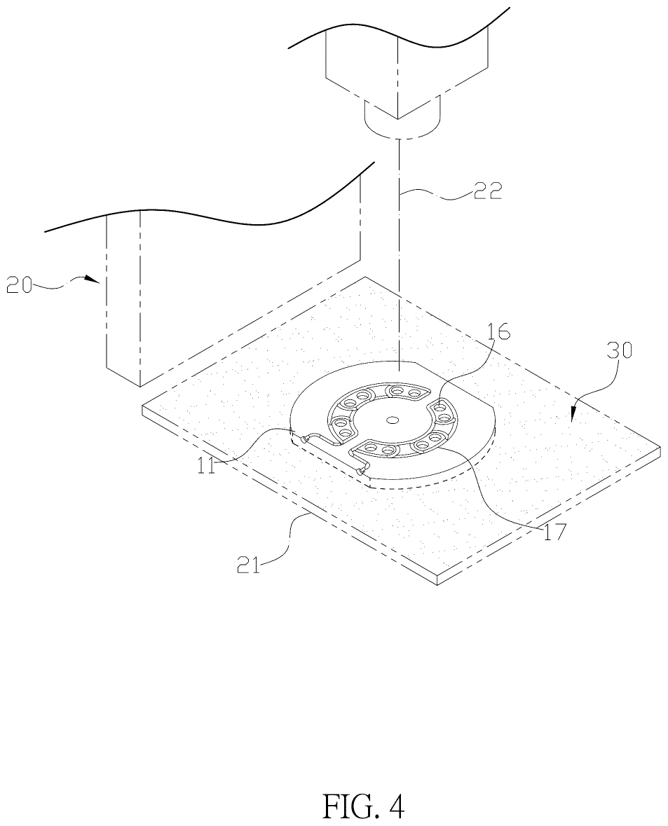

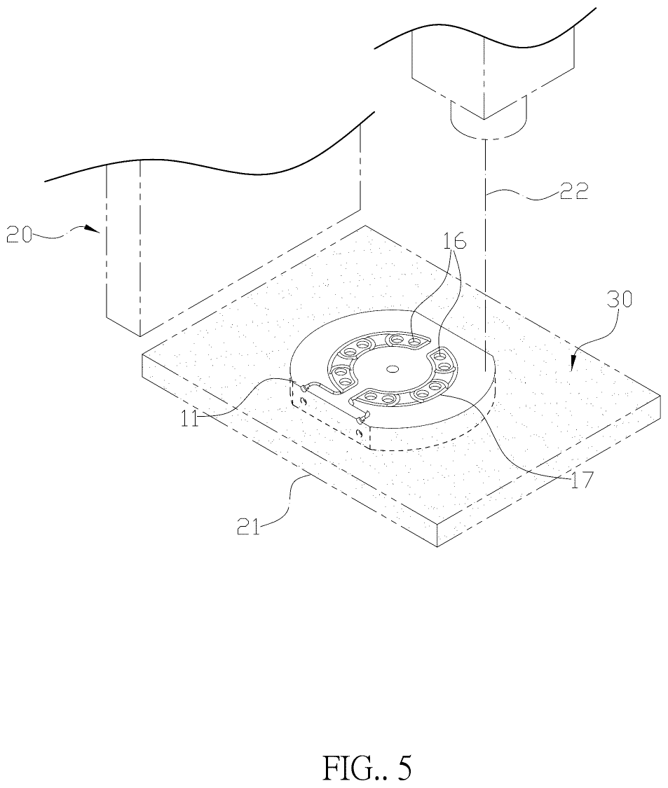

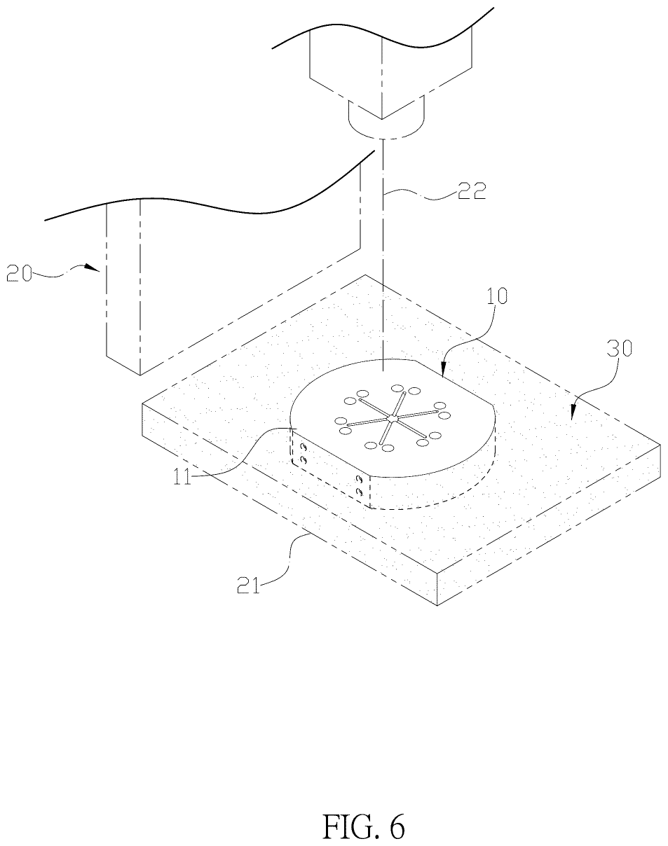

First, please refer to FIGS. 1-6. An optical lens injection molding module is presented, wherein the molding module has a mold core 10 made by a metal 3D printer 20. The metal 3D printer 20 first lays metal powder 30 on a platform 21 and then transmits laser 22 heat energy for irradiation sintering to melt the metal powder 30 together into a predetermined shape as a metal layer 11, and by repeated formation of a plurality of metal layers 11, the mold core 10 is created. The mold core 10 has a top surface 12, a bottom surface 13, a peripheral wall 14, a through aperture 15, a plurality of mold cavities 16, and at least one temperature controlled flow channel 17. The mold cavities 16 and the temperature controlled flow channel 17 are disposed in the mold core 10, and the temperature controlled flow channel 17 passes around each mold cavity 16 and penetrates the peripheral wall 14 with at least one intake opening 171 and at least one exit opening 172. The through aperture 15 is disposed at a center of a circular position of all the mold cavities 16, penetrates both of the top surface 12 and the bottom surface 13, and connects radially to each mold cavity 16 via a plurality of guiding grooves 151, such thar all of the through aperture 15, the guiding grooves 151, the mold cavities 16, the temperature controlled flow channel 17, the intake opening 171 and the exit opening 172 are formed during the printing process of the metal 3D printer 20.

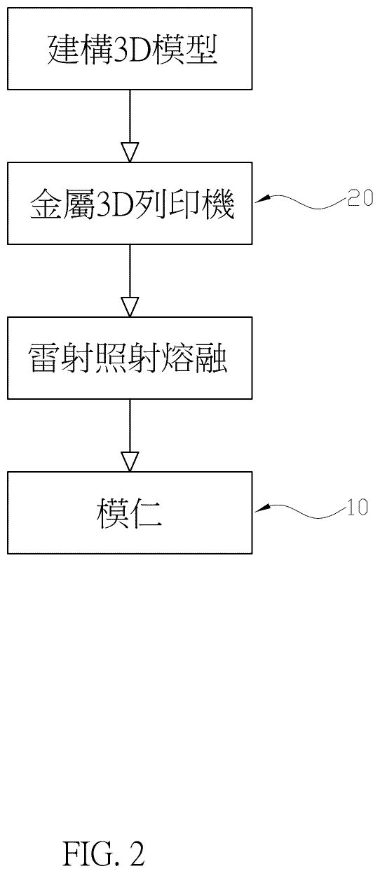

Furthermore, the mold core 10 is provided with a 3D model before the printing process, as shown in FIG. 2.

Moreover, the mold core 10 is mounted in the injection molding module, so that an optical lens is formed between the mold cavity 16 of the mold core 10 and the injection molding module by an injection molding process. Also, during the injection molding process, fluid flows through the temperature controlled flow channel 17 to raise or lower the temperature of the mold cavity 16, which enters from the intake opening 171 and exits from the exit opening 172.

In addition, wherein the mold cavity 16 has a cylindrical shape.

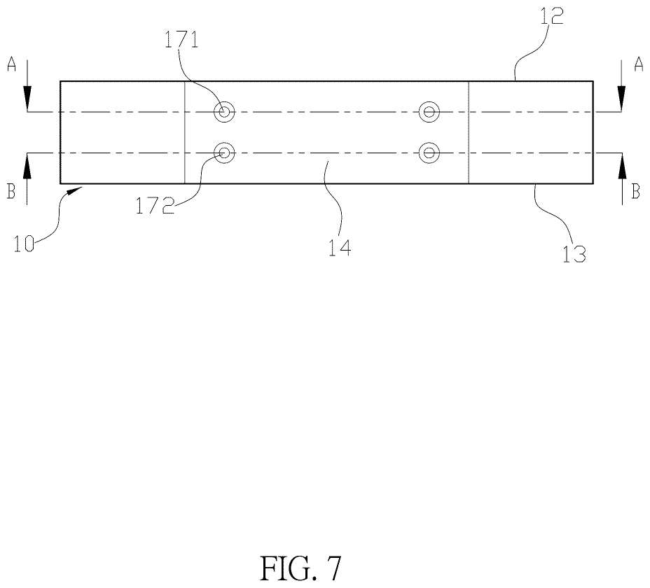

Moreover, the temperature controlled flow channel 17 can be multiple and disposed as different layers according to the height of the mold cavity 16, and each of the temperature controlled flow channels 17 is inter-connected, such that the fluid enters from the intake opening 171, moves through every layer of the temperature controlled flow channel 17, and then exits through the exit opening 172, as shown in FIGS. 7-9.

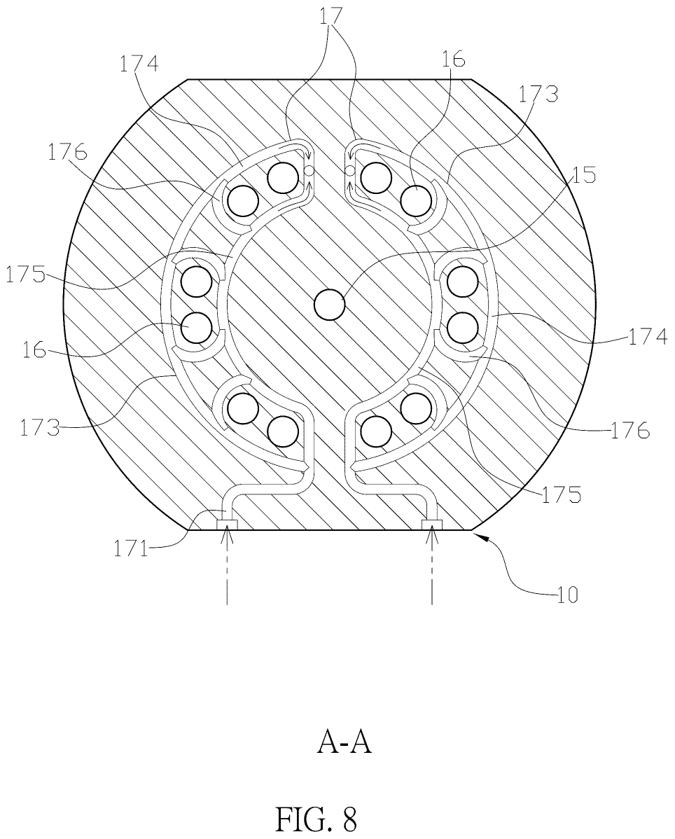

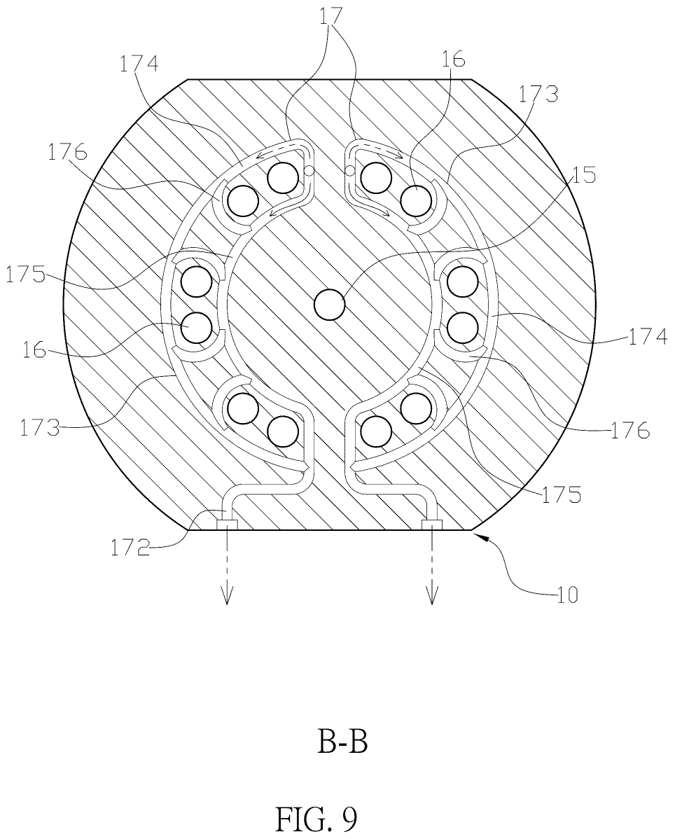

Additionally, each temperature controlled flow channel 17 has two opposite circular paths 173 with an outer circular section 174 and an inner circular section 175 respectively disposed along an outer edge and an inner edge of each mold cavity 16. Moreover, a plurality of connecting channels 176 are disposed between the outer circular section 174 and the inner circular section 175, as shown in FIGS. 8 and 9.

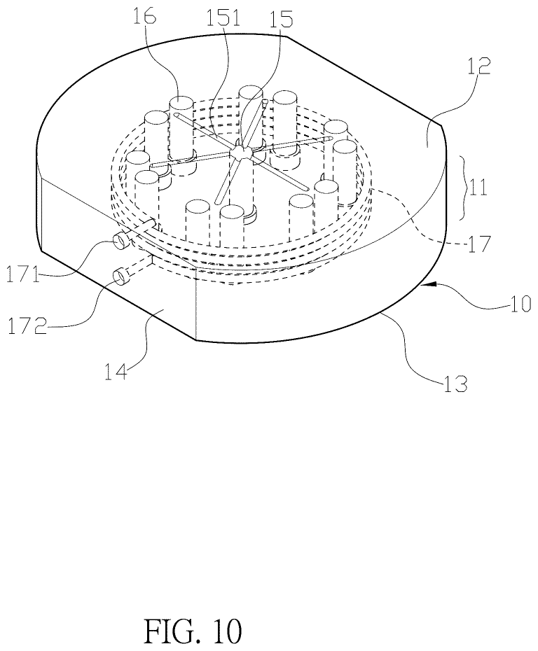

Also. the temperature controlled flow channel 17 is in a spiral shape, as shown in FIG. 10

In addition, the metal powder 30 is organic substance.

Alternatively, the metal powder 30 is inorganic substance.

The above-mentioned optical sheet has the following advantages: First, the mold core 10 uses the metal 3D printer 20 for printing and stacking, therefore there is no need to use other tools for cutting and then assembling, so that the manufacturing process of the mold core 10 has the advantages of fast production speed, lower processing cost and customizable. Secondly, the mold core 10 uses the metal 3D printer 20 for printing and stacking. therefore it has excellent integrity and can be completely sealed

Although the present invention has been explained in relation to its preferred embodiment, it is to be understood that many other possible modifications and variations can be made without departing from the spirit and scope of invention as hereinafter claimed.

What is claimed is:

1. An optical lens injection molding module, wherein:
the molding module has a mold core made by a metal 3D printer, wherein the metal 3D printer first lays metal powder on a platform and then transmits laser heat energy for irradiation sintering to melt the metal powder together into a predetermined shape as a metal layer, and by repeated formation of a plurality of metal layers, the mold core is created; the mold core has a top surface, a bottom surface, a peripheral wall, a through aperture, a plurality of mold cavities, and at least one temperature controlled flow channel; the mold cavities and the temperature controlled flow channel are disposed in the mold core, and the temperature controlled flow channel passes around each mold cavity and penetrates a peripheral wall with at least one intake opening and at least one exit opening; a through aperture is disposed at a center of a circular position of all the mold cavities, penetrates both of the top surface and the bottom surface, and connects radially to each mold cavity via a plurality of guiding grooves, and all of the through aperture, the guiding grooves, the mold cavities, the temperature controlled flow channel, the intake opening and the exit opening are formed during the printing process of the metal 3D printer; wherein, the temperature controlled flow channel can be multiple and disposed as different layers according to the height of the mold cavity, and each of the temperature controlled flow channels is inter-connected; each temperature controlled flow channel has two opposite circular paths with an outer circular section and an inner circular section respectively disposed along an outer edge and an inner edge of each mold cavity; moreover, a plurality of connecting channels are disposed between the outer circular section and the inner circular section.

2. The optical lens injection molding module as claimed in claim 1, wherein the mold core is provided with a 3D model before the printing process.

3. The optical lens injection molding module as claimed in claim 1, wherein the mold core is mounted in the injection molding module, so that an optical lens is formed between the mold cavity of the mold core and the injection molding module by an injection molding process; furthermore, during the injection molding process, fluid flows through the temperature controlled flow channel to raise or lower the temperature of the mold cavity, which enters from the intake opening and exits from the exit opening.

4. The optical lens injection molding module as claimed in claim 3, the fluid is a liquid.

5. The optical lens injection molding module as claimed in claim 3, wherein the fluid is a gas.

6. The optical lens injection molding module as claimed in claim 3, wherein the mold cavity has a cylindrical shape.
